(19) United States
(12) Patent Application Publication
(10) Pub. No.: US 2022/0383045 A1
(43) Pub. Date: Dec. 1, 2022

(54) GENERATING PSEUDO LESION MASKS FROM BOUNDING BOX ANNOTATIONS

(71) Applicant: INTERNATIONAL BUSINESS MACHINES CORPORATION, Armonk, NY (US)

(72) Inventors: Omid Bonakdar Sakhi, North York (CA); Pedro Luis Esquinas Fernandez, Etobicoke (CA); Paul Dufort, Toronto (CA); Vishnu Sanjay Ramiya Srinivasan, Coquitlam (CA)

(21) Appl. No.: 17/329,871

(22) Filed: May 25, 2021

(51) Int. Cl. G06K 9/62; G06T 7/00; G06T 7/11; G06T 7/13; G06N 3/04; G06N 3/08

(52) U.S. Cl. CPC G06K 9/6257; G06T 7/0012; G06T 7/11; G06T 7/13; G06N 3/0454; G06N 3/08; G06K 2209/05; G06T 2207/30096; G06T 2207/20081; G06T 2207/20076; G06T 2207/20084

(57) ABSTRACT

Methods and systems of generating pseudo lesion masks. One system includes an electronic processor configured to receive an annotated medical image, the annotated medical image including a bounding box annotation positioned around at least one lesion of the medical image. The electronic processor is also configured to generate, using a ground truth generator, a pseudo-mask candidate, the pseudo-mask candidate representing a pseudo lesion mask for the at least one lesion of the medical image. The electronic processor is also configured to train a segmentation model using the pseudo-mask candidate as ground truth.

### FIELD

Embodiments described herein generally relate to generating pseudo lesion masks from bounding box annotations to aid training of deep learning segmentation models.

### SUMMARY

Supervised training of deep learning models for segmentation requires ground truth segmentation masks. However, annotating segmentation masks is often very costly, especially in the healthcare domain (for example, lesion segmentation in the context of medical imaging). In particular, annotating lesion masks in two-dimensional (2-D) or three-dimensional (3-D) medical images is time consuming as the annotator needs to draw the contours of every lesion present in each image of a given study. Often studies might contain multiple lesions that might expand across multiple slices (where the study is in 3-D). Additionally, annotating a lesion mask generally requires an expert (for example, a radiologist). Finally, there is variability between annotators at determining the true boundaries of a lesion, which may impact overall performance of a deep learning model trained via supervised learning from a set of lesion masks generated by multiple annotators.

To solve these and other problems, embodiments described herein provide methods and systems for generating pseudo lesion masks from bounding box annotations to aid training of deep learning segmentation models. In particular, embodiments described herein allow for the training of a lesion segmentation model without the need of annotating all cases (in a training dataset) with lesion masks. Rather, embodiments described herein use bounding boxes (for example, in two-dimensions or three-dimensions). By using bounding boxes as opposed to annotated lesion masks, the efficiency of annotating training data is increased.

For example, one embodiment provides a system of generating pseudo lesion masks. The system includes an electronic processor configured to receive an annotated medical image, the annotated medical image including a bounding box annotation positioned around at least one lesion of the medical image. The electronic processor is also configured to generate, using a ground truth generator, a pseudo-mask candidate, the pseudo-mask candidate representing a pseudo lesion mask for the at least one lesion of the medical image. The electronic processor is also configured to train a segmentation model using the pseudo-mask candidate as ground truth.

Another embodiment provides a method of generating pseudo lesion masks. The method includes receiving, with an electronic processor, an annotated medical image, the annotated medical image including a bounding box annotation positioned around at least one lesion of the medical image. The method also includes generating, with the electronic processor using a ground truth generator, a pseudo-mask candidate, the pseudo-mask candidate representing a pseudo lesion mask for the at least one lesion of the medical image. The method also includes training, with the electronic processor, a segmentation model using the pseudo-mask candidate as ground truth.

Another embodiment provides a non-transitory, computer-readable medium storing instructions that, when executed by an electronic processor, perform a set of functions. The set of functions includes receiving an annotated medical image, the annotated medical image including a bounding box annotation positioned around at least one lesion of the medical image. The set of functions also includes generating, using a ground truth generator, a pseudo-mask candidate, the pseudo-mask candidate representing a pseudo lesion mask for the at least one lesion of the medical image. The set of functions also includes training a segmentation model using the pseudo-mask candidate as ground truth.

Other aspects of the embodiments described herein will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a system for generating pseudo lesion masks according to some embodiments.

FIG. 2 illustrates a server included in the system of FIG. 1 according to some embodiments.

FIG. 3 illustrates a method for generating pseudo lesion masks using the system of FIG. 1 according to some embodiments.

FIGS. 4A-4C illustrate example pseudo-mask candidates positioned within a bounding box according to some embodiments.

FIG. 5 illustrates an example implementation diagram of the method of FIG. 3 according to some embodiments.

FIG. 6 illustrates an example use case of a generator according to some embodiments.

FIG. 7A-7B illustrate a first experiment and a second experiment, respectively, performed on various datasets according to some embodiments.

FIG. 8 illustrates a table showing sample test cases for the first experiment of FIG. 7A and the second experiment of FIG. 7B according to some embodiments.

Other aspects of the embodiments described herein will become apparent by consideration of the detailed description.

### DETAILED DESCRIPTION

One or more embodiments are described and illustrated in the following description and accompanying drawings. These embodiments are not limited to the specific details provided herein and may be modified in various ways. Furthermore, other embodiments may exist that are not described herein. Also, the functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not listed. Furthermore, some embodiments described herein may include one or more electronic processors configured to perform the described functionality by executing instructions stored in non-transitory, computer-readable medium. Similarly, embodiments described herein may be implemented as non-transitory, computer-readable medium storing instructions executable by one or more electronic processors to perform the described functionality. As used herein, “non-transitory computer-readable medium” comprises all computer-readable media but does not consist of a transitory, propagating signal. Accordingly, non-transitory computer-readable medium may include, for example, a hard disk, a CD-ROM, an optical storage device, a magnetic storage device, a ROM (Read Only Memory), a RAM (Random Access Memory), register memory, a processor cache, or any combination thereof.

In addition, the phraseology and terminology used herein is for the purpose of description and should not be regarded as limiting. For example, the use of “including,” “containing,” “comprising,” “having,” and variations thereof herein is meant to encompass the items listed thereafter and equivalents thereof as well as additional items. The terms “connected” and “coupled” are used broadly and encompass both direct and indirect connecting and coupling. Further, “connected” and “coupled” are not restricted to physical or mechanical connections or couplings and can include electrical connections or couplings, whether direct or indirect. In addition, electronic communications and notifications may be performed using wired connections, wireless connections, or a combination thereof and may be transmitted directly or through one or more intermediary devices over various types of networks, communication channels, and connections. Moreover, relational terms such as first and second, top and bottom, and the like may be used herein solely to distinguish one entity or action from another entity or action without necessarily requiring or implying any actual such relationship or order between such entities or actions.

As described above, supervised training of deep learning models for lesion segmentation requires ground truth segmentation masks. However, annotating lesion masks is very costly. In particular, annotating a lesion mask is time consuming (for example, multiple lesions, multiple slices for a given case). Additionally, annotating a lesion mask generally requires an expert (for example, a radiologist). Finally, there is variability between annotators.

Therefore, to solve these and other issues with existing lesion segmentation technology, embodiments described herein generate pseudo lesion masks from bounding box annotations to aid training of deep learning segmentation models, which increases the efficiency of annotating training data. For example, embodiments described herein provide methods and systems for generating pseudo lesion masks from bounding box annotations such that the training of a lesion segmentation model may be performed without the need of annotating all cases (in a training dataset) with lesion masks. Rather, embodiments described herein use bounding boxes (for example, in two-dimensions or three-dimensions). By using bounding boxes as opposed to annotated lesion masks, the efficiency of annotating training data is increased.

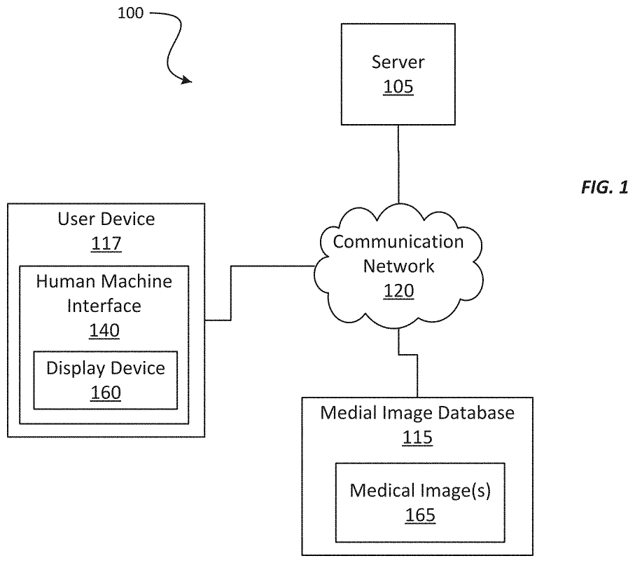

FIG. 1 schematically illustrates a system 100 for generating pseudo lesion masks according to some embodiments. The system 100 includes a server 105, a medical image database 115, and a user device 117. In some embodiments, the system 100 includes fewer, additional, or different components than illustrated in FIG. 1. For example, the system 100 may include multiple servers 105, medical image databases 115, user devices 117, or a combination thereof.

The server 105, the medical image database 115, and the user device 117 communicate over one or more wired or wireless communication networks 120. Portions of the communication network 120 may be implemented using a wide area network, such as the Internet, a local area network, such as a Bluetooth™ network or Wi-Fi, and combinations or derivatives thereof. Alternatively or in addition, in some embodiments, components of the system 100 communicate directly as compared to through the communication network 120. Also, in some embodiments, the components of the system 100 communicate through one or more intermediary devices not illustrated in FIG. 1.

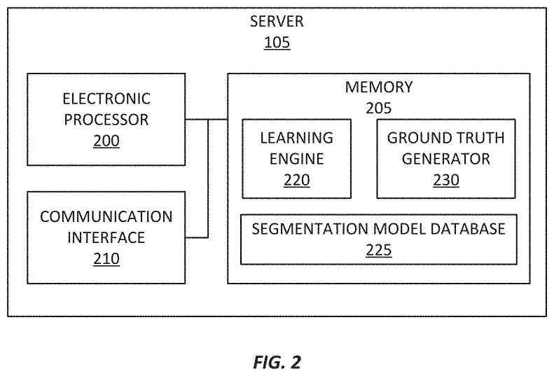

The server 105 is a computing device, which may server as a gateway for the medical image database 115. For example, in some embodiments, the server 105 may be a PACS server. Alternatively, in some embodiments, the server 105 may be a server that communicates with a PACS server to access the medical image database 115. As illustrated in FIG. 2, the server 105 includes an electronic processor 200, a memory 205, and a communication interface 210. The electronic processor 200, the memory 205, and the communication interface 210 communicate wirelessly, over one or more communication lines or buses, or a combination thereof. The server 105 may include additional components than those illustrated in FIG. 2 in various configurations. The server 105 may also perform additional functionality other than the functionality described herein. Also, the functionality described herein as being performed by the server 105 may be distributed among multiple devices, such as multiple servers included in a cloud service environment. In addition, in some embodiments, the user device 117 may be configured to perform all or a portion of the functionality described herein as being performed by the server 105.

The electronic processor 200 includes a microprocessor, an application-specific integrated circuit (ASIC), or another suitable electronic device for processing data. The memory 205 includes a non-transitory computer-readable medium, such as read-only memory (“ROM”), random access memory (“RAM”) (for example, dynamic RAM (“DRAM”), synchronous DRAM (“SDRAM”), and the like), electrically erasable programmable read-only memory (“EEPROM”), flash memory, a hard disk, a secure digital (“SD”) card, another suitable memory device, or a combination thereof. The electronic processor 200 is configured to access and execute computer-readable instructions (“software”) stored in the memory 205. The software may include firmware, one or more applications, program data, filters, rules, one or more program modules, and other executable instructions. For example, the software may include instructions and associated data for performing a set of functions, including the methods described herein.

For example, as illustrated in FIG. 2, the memory 205 may store a learning engine 220 and a segmentation model database 225. In some embodiments, the learning engine 220 develops a segmentation model (for example, a lesion segmentation model) using one or more machine learning functions. Machine learning functions are generally functions that allow a computer application to learn without being explicitly programmed. In particular, a computer application performing machine learning functions (sometimes referred to as a learning engine) is configured to develop an algorithm based on training data. For example, to perform supervised learning, the training data includes example inputs and corresponding desired (for example, actual) outputs, and the learning engine progressively develops a model (for example, a segmentation model) that maps inputs to the outputs included in the training data. Machine learning may be performed using various types of methods and mechanisms including but not limited to decision tree learning, association rule learning, artificial neural networks, inductive logic programming, support vector machines, clustering, Bayesian networks, reinforcement learning, representation learning, similarity and metric learning, sparse dictionary learning, and genetic algorithms. Using all of these approaches, a computer program may ingest, parse, and understand data and progressively refine models for data analytics, including image analytics.

Accordingly, the learning engine 220 (as executed by the electronic processor 200) may perform machine learning using training data (for example, using ground truth) to develop a segmentation model that performs lesion segmentation with respect to one or more medical images (for example, the medical images stored in the medical image database 115). In other words, the segmentation model detects and segments one or more lesions included in a medical image. The training data may include, for example, medical images including at least one lesion and associated lesion masks (as ground truth).

Segmentation models generated by the learning engine 220 may be stored in the segmentation model database 225. As illustrated in FIG. 2, the segmentation model database 225 is included in the memory 205 of the server 105. It should be understood that, in some embodiments, the segmentation model database 225 is included in a separate device accessible by the server 105 (included in the server 105 or external to the server 105).

As seen in FIG. 2, the memory 205 also includes a ground truth generator 230. In some embodiments, the ground truth generator 230 is a software application executable by the electronic processor 200. As described in more detail below, the electronic processor 200 executes the ground truth generator 230 to generate one or more pseudo-mask candidates (for example, an annotated pseudo-mask, an annotated lesion pseudo-mask, or the like). The pseudo-mask candidates generated by the ground truth generator 230 may be used as training data for the segmentation model(s) stored in the segmentation model database. As described in greater detail below, the electronic processor 200 may receive a medical image including an annotated bounding box surrounding (or positioned around) a lesion included in the medical image. The electronic processor 200 (via the ground truth generator 230) may analyze the received medical image and generate one or more pseudo-mask candidates (as training data or ground truth) based on the received medical image.

The communication interface 210 allows the server 105 to communicate with devices external to the server 105. For example, as illustrated in FIG. 1, the server 105 may communicate with the medical image database 115, the user device 117, or a combination thereof through the communication interface 210. In particular, the communication interface 210 may include a port for receiving a wired connection to an external device (for example, a universal serial bus (“USB”) cable and the like), a transceiver for establishing a wireless connection to an external device (for example, over one or more communication networks 120, such as the Internet, local area network (“LAN”), a wide area network (“WAN”), and the like), or a combination thereof.

The user device 117 is also a computing device and may include a desktop computer, a terminal, a workstation, a laptop computer, a tablet computer, a smart watch or other wearable, a smart television or whiteboard, or the like. Although not illustrated, the user device 117 may include similar components as the server 105 (an electronic processor, a memory, and a communication interface). The user device 117 may also include a human-machine interface 140 for interacting with a user. The human-machine interface 140 may include one or more input devices, one or more output devices, or a combination thereof. Accordingly, in some embodiments, the human-machine interface 140 allows a user to interact with (for example, provide input to and receive output from) the user device 117. For example, the human-machine interface 140 may include a keyboard, a cursor-control device (for example, a mouse), a touch screen, a scroll ball, a mechanical button, a display device (for example, a liquid crystal display (“LCD”)), a printer, a speaker, a microphone, or a combination thereof. As illustrated in FIG. 1, in some embodiments, the human-machine interface 140 includes a display device 160. The display device 160 may be included in the same housing as the user device 117 or may communicate with the user device 117 over one or more wired or wireless connections. For example, in some embodiments, the display device 160 is a touchscreen included in a laptop computer or a tablet computer. In other embodiments, the display device 160 is a monitor, a television, or a projector coupled to a terminal, desktop computer, or the like via one or more cables.

Additionally, in some embodiments, to communicate with the server 110, the user device 117 may store a browser application or a dedicated software application executable by an electronic processor. The system 100 is described herein as providing a lesion segmentation and lesion mask generation service through the server 110. However, in other embodiments, the functionality described herein as being performed by the server 110 may be locally performed by the user device 117. For example, in some embodiments, the user device 117 may store the learning engine 220, the segmentation model database 225, the ground truth generator 230, or a combination thereof.

The medical image database 115 stores a plurality of medical images 165. In some embodiments, the medical image database 115 is combined with the server 105. Alternatively or in addition, the medical images 165 may be stored within a plurality of databases, such as within a cloud service. Although not illustrated in FIG. 1, the medical image database 115 may include components similar to the server 105, such as an electronic processor, a memory, a communication interface and the like. For example, the medical image database 115 may include a communication interface configured to communicate (for example, receive data and transmit data) over the communication network 120.

The medical images 165 stored in the medical image database 115 may include a variety of classifications or types. For example, the medical images 165 may include anatomical images, such as a lateral chest radiograph, a PA chest radiograph, and the like. In some embodiments, a memory of the medical image database 115 stores the medical images 165 and associated data (for example, reports, metadata, and the like). For example, the medical image database 115 may include a picture archiving and communication system (“PACS”), a radiology information system (“RIS”), an electronic medical record (“EMR”), a hospital information system (“HIS”), an image study ordering system, and the like.

A user may use the user device 117 to access and view the medical images 165 and interact with the medical images 165. For example, the user may access the medical images 165 from the medical image database 115 (through a browser application or a dedicated application stored on the user device 117 that communicates with the server 105) and view the medical images 165 on the display device 160 associated with the user device 117. Alternatively or in addition, the user may access the medical images 165 from the medical image database 115 and annotate the medical images 165 (via the human machine interface 140 of the user device 117). As one example, the user may annotate a medical image 165 by adding a bounding box around a lesion included in the medical image 165.

As noted above, annotating lesion masks in medical images 165 is time consuming (for example, multiple lesions, where lesion masks need to be drawn on each slice where the lesion is present a given case, and the like) and generally requires an expert (for example, a radiologist). To solve these and other problems, the system 100 is configured to automatically generate pseudo-mask candidates (for example, pseudo lesion masks) from bounding box annotations to aid training of deep learning segmentation models (for example, the models stored in the segmentation model database 225). The methods and systems described herein train (or re-train) the segmentation model(s) stored in the segmentation model database 225 using the pseudo-mask candidates as training data (or ground truth).

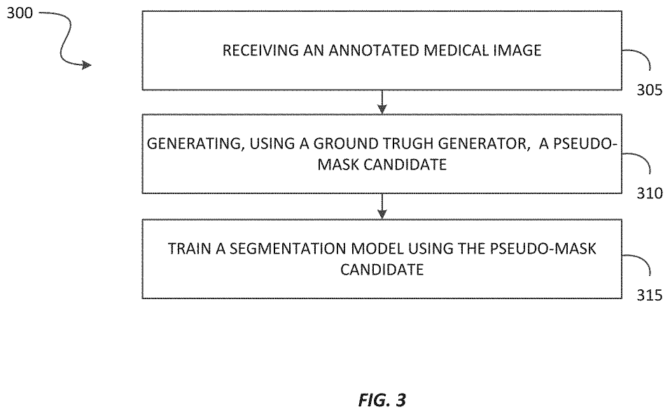

For example, FIG. 3 is a flowchart illustrating a method 300 for generating pseudo lesion masks according to some embodiments. The method 300 is described herein as being performed by the server 105 (the electronic processor 200 executing instructions). However, as noted above, the functionality performed by the server 105 (or a portion thereof) may be performed by other devices, including, for example, the user device 117 (via an electronic processor executing instructions).

As illustrated in FIG. 3, the method 300 includes receiving, with the electronic processor 200, an annotated medical image (at block 305). In some embodiments, the annotated medical image includes an annotation of a bounding box positioned around at least one lesion of the medical image (for example, a bounding box annotation). As noted above, in some embodiments, a user (such as a radiologist) may access the medical images 165 from the medical image database 115 and annotate the medical images 165, where the annotation may include a bounding box annotation positioned around a lesion included in the medical image 165. After annotating the medical images 165, the user may store the annotated medical images in, for example, the medical image database 115 (for example, as the medical images 165). Accordingly, in some embodiments, the medical image database 115 stores annotated medical images (as the medical images 165). In such embodiments, the electronic processor 200 receives the annotated medical image from the medical image database 115 over the communication network 120. Alternatively or in addition, the annotated medical image may be stored in another storage location, such as the memory of the user device 117. Accordingly, in some embodiments, the electronic processor 200 receives the annotated medical image from another storage location (for example, the memory of the user device 117).

After receiving the annotated medical image (at block 305), the electronic processor 200 (using the ground truth generator 230) generates a pseudo-mask candidate (at block 310). As noted above, the pseudo-mask candidate may represent a pseudo lesion mask for the lesion included in the annotated medical image. The pseudo-mask candidate may include a two-dimensional lesion mask or a three-dimensional lesion mask. For embodiments where a three-dimensional lesion mask is generated, the bounding box annotation may be a three-dimensional bounding box annotation.

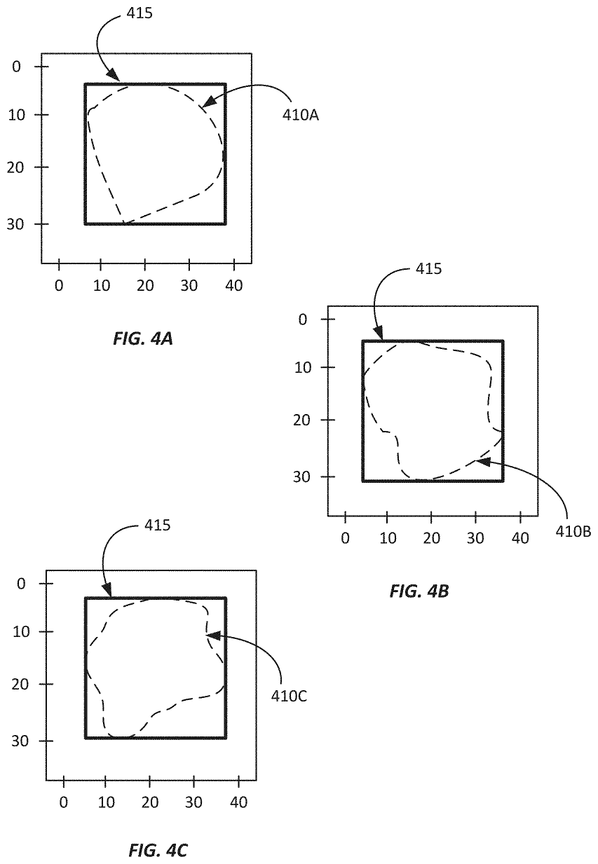

In some embodiments, the electronic processor 200 (i.e., the ground truth generator 230) generates the pseudo-mask candidate by generating a shape. As noted above, the pseudo-mask candidate may include a two-dimensional lesion mask or a three-dimensional lesion mask. Accordingly, the shape may include a two-dimensional shape or a three-dimensional shape, such as, for example, a two-dimensional circle, a two-dimensional ellipse, a three-dimensional sphere, or the like. The electronic processor 200 may position (or fit) the shape within the bounding box of the annotated medical image. The electronic processor 200 may then deform the shape within the bounding box, where the deformed shape represents the pseudo-mask candidate. The electronic processor 200 may deform the shape by, for example, adjusting one or more boundaries (or boundary points) of the shape (i.e., the boundary defining the shape or area of the shape). For example, FIGS. 4A-4C illustrate example pseudo-mask candidates 410A-410C positioned within a bounding box 415.

Alternatively or in addition, in some embodiments, the electronic processor 200 (i.e., the ground truth generator 230) generates the pseudo-mask candidate using an edge detection process. In such embodiments, the electronic processor 200 may execute an edge detection process on the medical image 165 to determine one or more boundaries of the lesion included in the medical image 165. In particular, the electronic processor 200 may estimate rough or estimated lesion boundaries within the bounding box of the medical image 165. After determining the boundaries of the lesion, the electronic processor 200 may then deform at least one of the boundaries of the lesion to generate the pseudo-mask candidate (i.e., the ground truth).

Alternatively or in addition, in some embodiments, the electronic processor 200 (i.e., the ground truth generator 230) generates the pseudo-mask candidate using a pre-existing segmentation model. The pre-existing segmentation model may be based on machine learning, and may have been trained using a fully annotated training dataset that is smaller (in terms of number of cases) than the dataset being used to train the segmentation model. In such embodiments, the electronic processor 200 may access the pre-existing segmentation model (for example, a segmentation model stored in the segmentation model database 225). After accessing the pre-existing segmentation model, the electronic processor 200 uses the pre-existing segmentation model to generate an approximate or estimated lesion mask that fits within the bounding box annotation of the medical image 165. The electronic processor 200 may then deform at least one boundary of the approximate or estimated lesion mask as a deformed approximate lesion mask, where the deformed approximate lesion mask is used as the pseudo-mask candidate.

Alternatively or in addition, in some embodiments, the electronic processor 200 (i.e., the ground truth generator 230) generates the pseudo-mask candidate using a collection of previously annotated lesion masks. For example, in some embodiments, the medical images 165 stored in the medical image database 115 (or a portion thereof) are medical images 165 that were previously annotated with lesion masks. In such embodiments, the electronic processor 200 may sample the previously annotated lesion masks from the collection of previously annotated lesion masks. The electronic processor 200 may deform the sampled lesion masks (for example, by altering at least one boundary of a lesion mask). After deforming the sampled lesion mask, the electronic processor 200 may then position (or fit) the deformed sampled lesion mask into the bounding box annotation of the medical image 165 as the pseudo-mask candidate.

Alternatively or in addition, in some embodiments, the electronic processor 200 (i.e., the ground truth generator 230) generates the pseudo-mask candidate using a collection of previously annotated lesion masks. For example, as noted above, in some embodiments, the medical images 165 stored in the medical image database 115 (or a portion thereof) are medical images 165 that were previously annotated with lesion masks. In such embodiments, the electronic processor 200 may determine a probability distribution of each lesion mask included in the collection of previously annotated lesion masks. The electronic processor 200 may then generate the pseudo-mask candidate based on the probability distribution.

Alternatively or in addition, in some embodiments, the electronic processor 200 (i.e., the ground truth generator 230) generates the pseudo-mask candidate using a generative adversarial network (GAN). In such embodiments, the electronic processor 200 trains a GAN configured to generate one or more lesion mask shapes (for example, realistic lesion mask shapes). In some embodiments, the GAN generates the lesion mask shapes using an input, such as a bounding box aspect ratio, a medical image (for example, a CT image), noise, or the like. After training the GAN, the electronic processor 200 may generate a lesion mask using the GAN, where the lesion mask is the pseudo-mask candidate.

After generating the pseudo-mask candidate (at block 310), the electronic processor 200 trains a segmentation model using the pseudo-mask candidate (at block 315). In some embodiments, the electronic processor 200 uses the pseudo-mask candidate as ground truth (or training data) for the segmentation model.

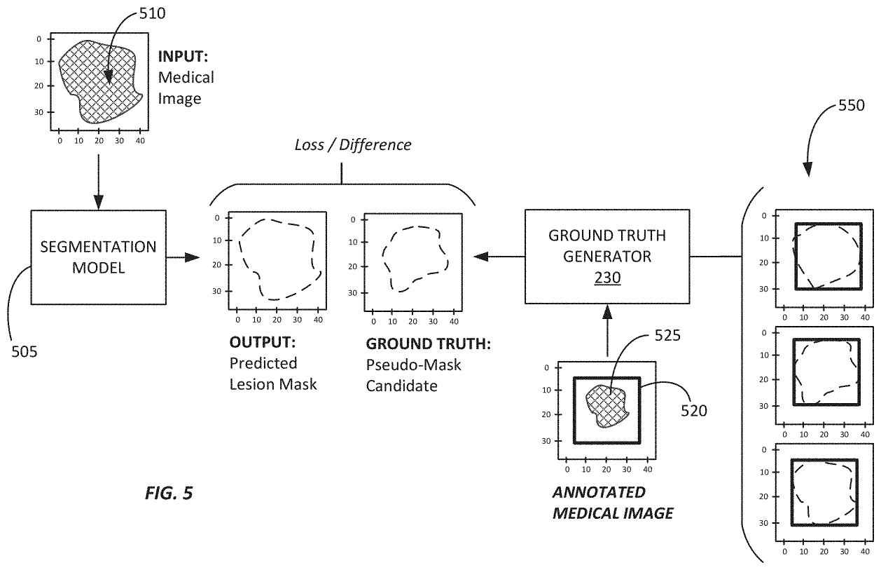

FIG. 5 illustrates an example implementation diagram of the method 300. As seen in FIG. 5, the segmentation model (represented in FIG. 5 by reference numeral 505) receives a medical image as input. In the illustrated example, the medical image 165 includes a lesion 510. The segmentation model 505 analyzes the medical image 165 and outputs a predicted lesion mask. As also seen in FIG. 5, the ground truth generator 230 receives an annotated medical image including a bounding box annotation (represented in FIG. 5 as reference numeral 520). The bounding box annotation is positioned around a lesion 525. As also seen in FIG. 5, the ground truth generator 230 includes (or accesses) a series or set of pseudo-mask candidates 550 (as “knowledge” for the ground truth generator 230). Based on the set of pseudo-mask candidates 550 and the annotated medical image, the ground truth generator 230 generates or provides a pseudo-mask candidate as ground truth.

In some embodiments, the electronic processor 200 is configured to update (or re-train) the segmentation model (for example, the segmentation model 505). The electronic processor 200 may update (or re-train) the segmentation model by comparing the predicted lesion mask and the pseudo-mask candidate and determine a difference (or error) between the predicted lesion mask and the pseudo-mask candidate, as seen in FIG. 5. Based on the difference (or error), the electronic processor 200 updates (or re-trains) the segmentation model using the difference (or error) as feedback data. In some embodiments, the electronic processor 200 receives a new medical image including a lesion. The electronic processor 200 may detect the lesion included in the medical image using the segmentation model (for example, the updated or re-trained segmentation model). The electronic processor 200 may automatically annotate the new medical image by adding a lesion indicator (for example, a lesion mask or the like) for the detected lesion to the new medical image.

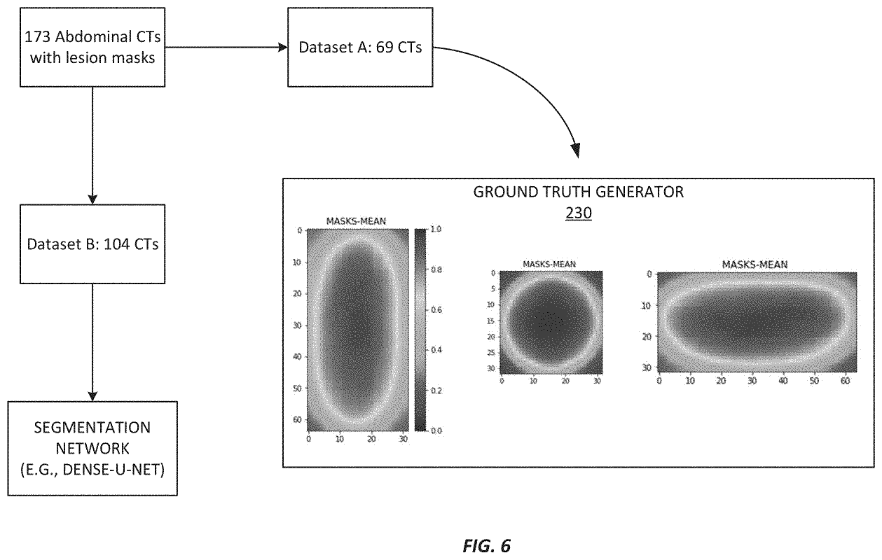

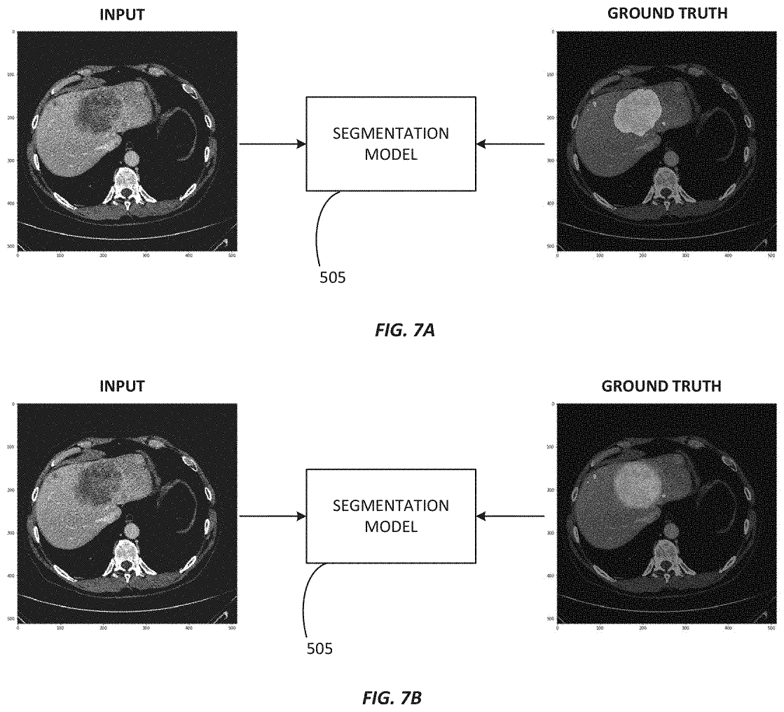

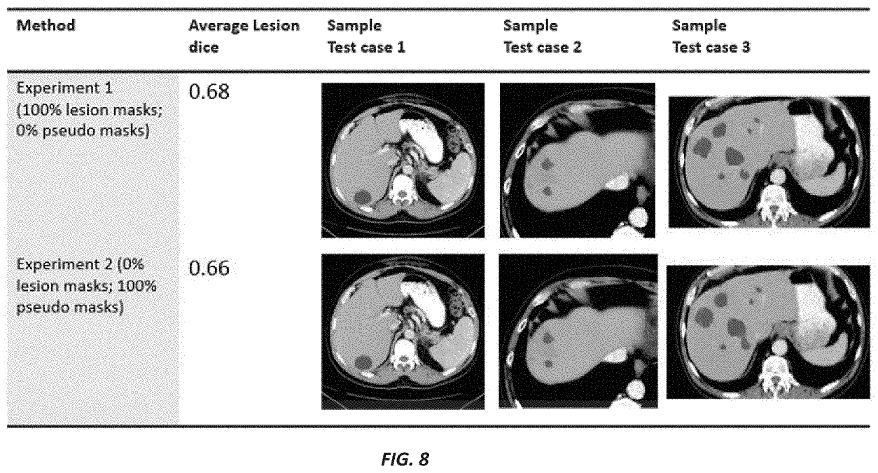

FIG. 6 illustrates an example use case of a generator (i.e., the ground truth generator 230). As seen in FIG. 6, 173 abdominal CTs with ground truth lesion masks generated by expert radiologists (for example, medical images) may be split into two datasets, a Dataset A and a Dataset B. Dataset A includes 69 CTs and Dataset B includes 104 CTs. Dataset A may be used to build knowledge for the ground truth generator 230, as seen in FIG. 6. In the illustrated example, the ground truth generator 230 includes three aspect ratios represented in FIG. 6 as heat maps or average mask distributions. In particular, the three aspect ratios are illustrated in FIG. 6 as a vertical rectangle heat map, a square heat map, and a horizontal heat map. In some embodiments, the average mask distribution (for example, a soft mask) are computed by re-scaling and overlapping the lesion masks in the ground-truth of Dataset A. Dataset B may be used to run experiments and/or train the segmentation network, as seen in FIG. 6. FIGS. 7A and 7B illustrate a first experiment and a second experiment, respectively, performed with respect to Dataset B. With respect to FIG. 7A, the first experiment involves training the segmentation model using Dataset B and the expert-generated ground truth lesion masks for each of the CTs included in Dataset B. With respect to FIG. 7B, the second experiment involves training the segmentation model using Dataset B while replacing the lesion masks for each of the CTs included in Dataset B with the average mask distribution (as seen in FIG. 6). FIG. 8 illustrates a table showing sample test cases for the first experiment of FIG. 7A and the second experiment of FIG. 7B. As seen in FIG. 8, the first experiment resulted in an average lesion dice coefficient of 0.68. As also seen in FIG. 8, the second experiment resulted in an average lesion dice coefficient of 0.66. The dice coefficient is a quantity commonly used to evaluate the quality of the segmentation generated by a system (for example, a machine learning model) against the ground truth segmentation mask (provided by an expert annotator). The dice coefficient ranges from 0 to 1, with perfect segmentation resulting in a dice equal to 1.

Accordingly, generating a bounding-box annotation generally requires less work than generating a different, more precise annotation of a lesion. For example, a user may be able to quickly add one or more bounding boxes to an image (for example, four points per lesion for two-dimensions and eight points per lesion for three-dimensions) as compared to marking, with greater precision the boundaries of each lesion represented within an image. Thus, automatically generating ground truth from two-dimensional or three-dimensional bounding boxes generally allows training data (i.e., ground truth) to be generated more quickly and efficiency than existing technology. Furthermore, the different ways a mask can be generated from a bounding-box annotation as described above, allows the complexity and accuracy of the system to be configured and controlled as needed.

Various features and advantages of the embodiments described herein are set forth in the following claims.

What is claimed is:

1. A system of generating pseudo lesion masks, the system comprising:
an electronic processor configured to
receive an annotated medical image, the annotated medical image including a bounding box annotation positioned around at least one lesion of the medical image,
generate, using a ground truth generator, a pseudo-mask candidate, the pseudo-mask candidate representing a pseudo lesion mask for the at least one lesion of the medical image, and
train a segmentation model using the pseudo-mask candidate as ground truth.

2. The system of claim 1, wherein the electronic processor is configured to
receive a new medical image, the new medical image including a lesion,
detect and segment, using the segmentation model, the lesion included in the new medical image using the segmentation model, and
automatically annotate the new medical image by adding a lesion indicator for the detected lesion to the new medical image.

3. The system of claim 1, wherein the electronic processor is configured to update the segmentation model by
comparing a predicted lesion mask and the pseudo-mask candidate,
determining a difference between the predicted lesion mask and the pseudo-mask candidate based on the comparison, and
re-training the segmentation model using the difference as feedback data.

4. The system of claim 1, wherein the pseudo-mask candidate is a two-dimensional lesion mask.

5. The system of claim 1, wherein the pseudo-mask candidate is a three-dimensional lesion mask.

6. The system of claim 1, wherein the electronic processor is configured to generate the pseudo-mask candidate by
generating and positioning a shape within the bounding box annotation, and
deforming at least one boundary of the shape to generate the pseudo-mask candidate.

7. The system of claim 1, wherein the electronic processor is configured to generate the pseudo-mask candidate by
executing an edge detection process on the medical image to determine one or more boundaries of the lesion, and
deforming at least one boundary of the one or more boundaries to generate the pseudo-mask candidate.

8. The system of claim 1, wherein the electronic processor is configured to generate the pseudo-mask candidate by
sampling a previously annotated lesion mask from a set of previously annotated lesion masks,
deforming at least one boundary of the previously annotated lesion mask, and
positioning the previously annotated lesion mask into the bounding box annotation to generate the pseudo-mask candidate.

9. The system of claim 1, wherein the electronic processor is configured to generate the pseudo-mask candidate by
accessing a set of previously annotated lesion masks,
determining a probability distribution of each lesion mask included in the set of previously annotated lesion masks, and
generating the pseudo-mask candidate based on the probability distribution.

10. The system of claim 1, wherein the electronic processor is configured to generate the pseudo-mask candidate by
training a generative adversarial network (GAN), the GAN configured to generate a lesion mask shape, and
generating a lesion mask using the GAN, wherein the lesion mask is the pseudo-mask candidate.

11. The system of claim 1, wherein the electronic processor is configured to generate the pseudo-mask candidate by
accessing a preexisting segmentation model,
generating, using the preexisting segmentation model, an approximate lesion mask that fits within the bounding box annotation, and
deforming at least one boundary of the approximate lesion mask as a deformed approximate lesion mask, wherein the deformed approximate lesion mask is the pseudo-mask candidate.

12. A method of generating pseudo lesion masks, the method comprising:
receiving, with an electronic processor, an annotated medical image, the annotated medical image including a bounding box annotation positioned around at least one lesion of the medical image;
generating, with the electronic processor using a ground truth generator, a pseudo-mask candidate, the pseudo-mask candidate representing a pseudo lesion mask for the at least one lesion of the medical image; and
training, with the electronic processor, a segmentation model using the pseudo-mask candidate as ground truth.

13. The method of claim 12, wherein generating the pseudo-mask candidate includes
generating and positioning a shape within the bounding box annotation, and
deforming at least one boundary of the shape to generate the pseudo-mask candidate.

14. The method of claim 12, wherein generating the pseudo-mask candidate includes
executing an edge detection process on the medical image to determine one or more boundaries of the lesion, and
deforming at least one boundary of the one or more boundaries to generate the pseudo-mask candidate.

15. The method of claim 12, wherein generating the pseudo-mask candidate includes
sampling a previously annotated lesion mask from a set of previously annotated lesion masks,
deforming at least one boundary of the previously annotated lesion mask, and
positioning the previously annotated lesion mask into the bounding box annotation to generate the pseudo-mask candidate.

16. A non-transitory, computer-readable medium storing instructions that, when executed by an electronic processor, perform a set of functions, the set of functions comprising:
receiving an annotated medical image, the annotated medical image including a bounding box annotation positioned around at least one lesion of the medical image;
generating, using a ground truth generator, a pseudo-mask candidate, the pseudo-mask candidate representing a pseudo lesion mask for the at least one lesion of the medical image; and
training a segmentation model using the pseudo-mask candidate as ground truth.

17. The computer-readable medium of claim 16, wherein generating the pseudo-mask candidate includes
accessing a set of previously annotated lesion masks,
determining a probability distribution of each lesion mask included in the set of previously annotated lesion masks, and
generating the pseudo-mask candidate based on the probability distribution.

18. The computer-readable medium of claim 16, wherein generating the pseudo-mask candidate includes
training a generative adversarial network (GAN), the GAN configured to generate a lesion mask shape, and
generating a lesion mask using the GAN, wherein the lesion mask is the pseudo-mask candidate.

19. The computer-readable medium of claim 16, wherein generating the pseudo-mask candidate includes
accessing a preexisting segmentation model,
generating, using the preexisting segmentation model, an approximate lesion mask that fits within the bounding box annotation, and
deforming at least one boundary of the approximate lesion mask as a deformed approximate lesion mask, wherein the deformed approximate lesion mask is the pseudo-mask candidate.

20. The computer-readable medium of claim 16, wherein the set of functions further comprises updating the segmentation model by
comparing a predicted lesion mask and the pseudo-mask candidate,
determining a difference between the predicted lesion mask and the pseudo-mask candidate based on the comparison, and
re-training the segmentation model using the difference as feedback data.
